(19) United States
(12) Patent Application Publication
(10) Pub. No.: US 2008/0002090 A1
(43) Pub. Date: Jan. 3, 2008

(54) TFT master substrate for LCD panels and method for fabricating the same

(75) Inventors: Shih-Yao Lin, Miao-Li (TW); Ming-Yao Kuo, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/824,837

(22) Filed: Jul. 2, 2007

(30) Foreign Application Priority Data
Jun. 30, 2006 (TW) 95123818

(51) Int. Cl. G02F 1/1333; G02F 1/1343

(52) U.S. Cl. 349/54; 349/143

(57) ABSTRACT

An exemplary thin film transistor master substrate for a liquid crystal display panel includes a plurality of display areas, a plurality of first detection areas set corresponding to the display areas and a second detection area set at a periphery of the thin film transistor master substrate. Each of the first detection areas is electrically coupled to the corresponding display areas and the first detection areas are coupled in parallel to the second detection area.

### BACKGROUND OF THE INVENTION

1. Field of the Invention

The invention relates to liquid crystal panels of liquid crystal displays (LCDs) that are mass produced, and more particularly to a detection technique utilized in the manufacture of LCD panels.

2. General Background

Liquid crystal displays (LCDs) generally have advantages of lightness in weight, a thin profile, flexible sizing, and low power consumption. For these reasons, LCDs are widely used in products such as laptops, personal digital assistants, mobile phones, and so on. Such kinds of products are referred to herein as LCD devices. Generally, an LCD panel is a key component of an LCD device. The major components of a typical LCD panel include two substrates, and a liquid crystal (LC) layer interposed between the substrates. During the process of manufacturing LCD devices, there are usually four major steps involved. These steps are the manufacture of thin film transistor (TFT) array substrates, the manufacture of color filter (CF) substrates, the manufacture of LCD panel assemblies, and the manufacture of LCD module assemblies.

Among the aforesaid four major manufacturing steps, the manufacture of LCD panel assemblies has the most significant impact on the yield rate of manufactured LCD devices. The ODF (One Drop Fill) process is a revolutionary technology currently utilized in LCD panel manufacture. The utilization of this state-of-the-art technology increases the efficiency of manufacturing large sized LCD panels in particular. However, there are certain manufacturing difficulties involved in the ODF process. As a result, the yield rate is normally rather low. In order to increase the yield rate and improve product quality, there is a need to inspect and test the LCD panels during or after the manufacturing process. Then necessary adjustments and improvements can be made to the manufacturing process.

Referring to FIG. 4, this is a schematic, exploded, isometric view of a conventional LCD panel set. The LCD panel set 1 is obtained at one stage in manufacturing of a plurality of LCD panels together in a batch. The LCD panel set 1 includes a TFT master substrate 11, a plurality of CF substrates 13, a plurality of LC layers 15, and a plurality of sealants 17. The LC layers 15 and sealants 17 are set individually on each of TFT substrate units (not labeled) of the TFT master substrate 11. Additionally, each of the CF substrates 13 is set corresponding to a respective one of the LC layers 15 and a respective one of the sealants 17. The LC layers 15 are interposed between the TFT substrate units of the TFT master substrate 11 and the corresponding CF substrates 13 respectively, and are hermetically sealed by the sealants 17 respectively. Each CF substrate 13 eventually forms part of a respective finished LCD panel (not shown). When the LCD panel is installed in a corresponding LCD device and the LCD device is being used by an end user, the CF substrate 13 enables full-color images to be displayed by the LCD device.

Referring to FIG. 5, this is a schematic, abbreviated, top plan view of the TFT master substrate 11. When a plurality of finished LCD panels (not shown) are eventually formed from the LCD panel set 1, an operating voltage is applied to specific electrodes formed on the TFT substrate (not shown) of each LCD panel. Thereby, the TFT substrate controls twist angles of liquid crystal molecules of the LC layer 15 of the LCD panel. Accordingly, the TFT master substrate 11 is provided with a plurality of detection areas 111 in addition to a plurality of display areas 112. That is, each TFT substrate unit has a detection area 111, and a display area 112 adjacent the detection area 111. In addition, the detection area 111 is set with a plurality of detection ports 1111. Preferably, each detection port 1111 includes a metal bump, so as to provide ready electrical contact with a corresponding test pin during a testing process (see below). The display area 112 includes a plurality of parallel address lines 1121 and a plurality of parallel data lines (not labeled), with the data lines being orthogonal to the address lines 1121. Thereby, a grid pattern is formed in the display area 112. The display area 112 further includes a plurality of TFT array circuits 1122, with each TFT array circuit 1122 located in a respective cell of the grid pattern. Electrical connection between the detection area 111 and the display area 112 includes connection between the detection ports 1111 and the address lines 1121.

A manufacturing process for obtaining the individual LCD panels from the LCD panel set 1 is typically as follows. Firstly, the TFT master substrate 11 is provided with the plurality of detection areas 111 and the plurality of display areas 112.

Secondly, the plurality of sealants 17 are set on boundary regions of the display areas 112 of the TFT master substrate 11. Thereby, a plurality of separate, individual receiving spaces are formed.

Thirdly, an ODF process is employed to fill liquid crystal into the receiving spaces. Thereby, the plurality of separate LC layers 15 is formed.

Fourthly, the plurality of CF substrates 13 are combined with the TFT master substrate 11, such that the LC layers 15 are sandwiched between the TFT master substrate 11 and respective CF substrates 13. The sealants 17 are cured, so that the TFT and CF substrates 11, 13 are tightly combined together. Thereby, the LCD panel set 1 is obtained.

Finally, the LCD panel set 1 is cut into individual pieces, each of which constitutes a finished LCD panel.

After the cutting step, there is a need to inspect and test the display areas 112 of the LCD panels. This is in order that a manufacturer can control the yield rate of the mass produced LCD panels. For each LCD panel, the inspection and testing process includes the testing of circuits of the TFT substrate, the strength of the hermetic seal provided by the sealant 17, the integrity and performance of the display area 112, etc. In the inspection and testing process, the test pins of the inspection equipment are connected to the detection ports 1111, such that test signals can be applied to the LCD panel including the display area 112 thereof. When defects are found during the inspection and testing process, the corresponding steps in the manufacturing process are identified. Where possible, adjustments or improvements are made to those manufacturing steps in order that the defects do not occur or at least occur less frequently.

In general, the above-described conventional inspection and testing process has the following disadvantages:

The inspection and testing process is performed after cutting of the LCD panel set 1 into the individual LCD panels. This means the display area 112 of every individual LCD panel must be tested separately. For example, after one LCD panel set 1 is cut into six LCD panels, the same inspection and testing process needs to be repeated 6 times.

Additionally, once a defect is found in an LCD panel, information about the defect is sent back to the corresponding workstation on the production line. Parameters of the manufacturing process can then be adjusted, so that the defect is eliminated or at least mitigated when subsequent LCD panel sets 1 are manufactured. However, there is a time lag between detection of the defect and correction of the problem at the workstation. During this intervening period, defective LCD panel sets 1 continue to be manufactured.

### SUMMARY

An exemplary thin film transistor (TFT) master substrate used for a liquid crystal display panel includes a plurality of display areas, a plurality of first detection areas set corresponding to the display areas and a second detection area set at a periphery of the TFT substrate. Each of the first detection areas is electrically coupled to the corresponding display areas respectively and the first detection areas are coupled in parallel to the first detection area. Additionally, each of the first detection areas further includes a first detection port and the second detection area further includes a second detection port connected to the first detection ports in parallel. The display areas include a plurality of metal lines connected to the corresponding first detection ports. The first detection ports further include a plurality of metal layers connected electrically to the corresponding metal lines of the display areas. The second detection ports include a plurality of metal bumps connected electrically to the first detection ports. In addition, a plurality of driving circuits set corresponding to each of the display areas. Each of the driving circuits includes a TFT array and a plurality of address lines.

An exemplary LCD panel set includes a plurality of CF substrates, a plurality of LC layers and a TFT substrate. The detail of the TFT substrate structures are described as above. Each of the liquid crystal layers interposed between the corresponding CF substrate and the TFT substrate.

An exemplary method for fabricating a liquid crystal display panel includes the following steps: (a) a TFT substrate is provided with the first detection areas and a second detection area arranged; (b) a plurality of sealants set around each of the display areas on the TFT substrate so as to define a plurality of corresponding receiving spaces within each center portion of the display areas; (c) a plurality of LC layers are formed separately into each of the receiving spaces. The preferred forming method is the ODF process; (d) a plurality of color filter substrates are provided so as to combine each of the color filter substrates to the corresponding display areas of the TFT substrate and sealed with the sealants structures, whereby an LCD panel set can be obtained; (e) an inspection and/or testing process is employed to the LCD panel set via the aforesaid detection areas; and (f) after the inspection and/or testing process is completed, a cutting process is applied to the detected LCD panel set (for detected “pass” unit) individually so as to obtain LCD panels.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of an LCD panel set according to a preferred embodiment of the present invention.

FIG. 2 is a top plan view of a TFT master substrate of the LCD panel set of FIG. 1.

FIG. 3 is an assembled view of the LCD panel set of FIG. 1, partly cut away.

FIG. 4 is an exploded, isometric view of a conventional LCD panel set.

FIG. 5 is a top plan view of a TFT master substrate of the LCD panel set of FIG. 4.

### DETAILED DESCRIPTION OF PREFERRED EMBODIMENTS

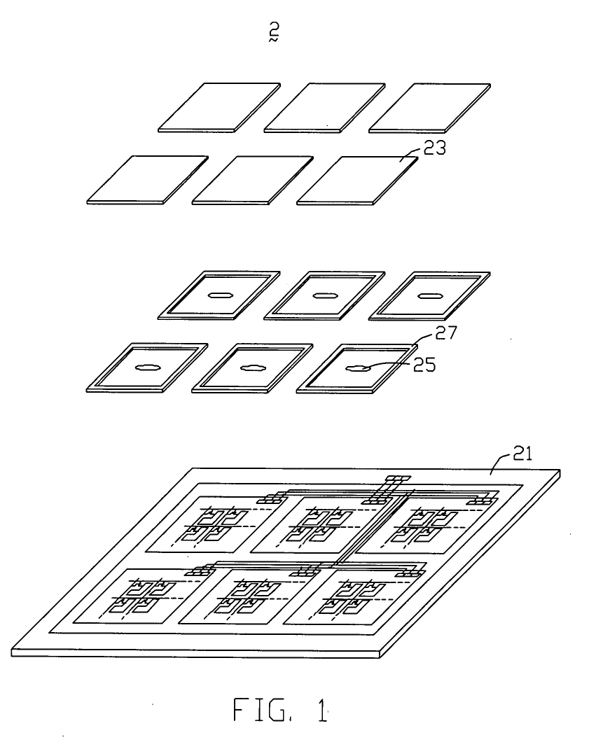

Referring to FIG. 1, this a schematic, exploded, isometric view of a liquid crystal display (LCD) panel set according to a preferred embodiment of the present invention. The LCD panel set 2 includes a TFT master substrate 21, a plurality of CF substrates 23, a plurality of LC layers 25, and a plurality of sealants 27. Each of the LC layers 25 and a corresponding one of the sealants 27 are set individually on each of TFT substrate units (not labeled) of the TFT master substrate 21. Additionally, each of the CF substrates 23 is set corresponding to a respective one of the LC layers 25 and a respective one of the sealants 27. The LC layers 25 are interposed between the TFT substrate units of the TFT master substrate 21 and the corresponding CF substrates 23 respectively, and are hermetically sealed by the sealants 27 respectively.

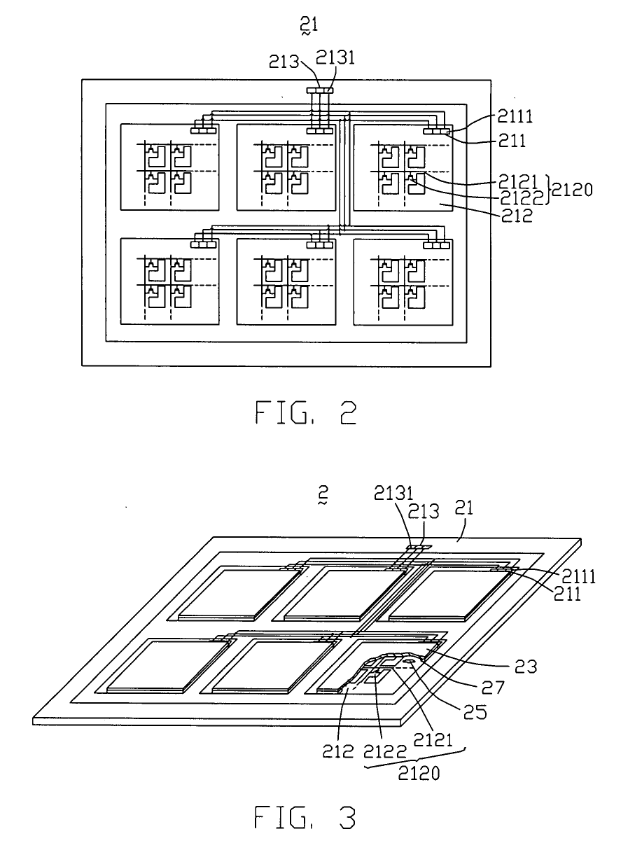

Referring to FIG. 2, this is a schematic, abbreviated, top plan view of the TFT master substrate 21. When a plurality of finished LCD panels (not shown) are eventually formed from the LCD panel set 2, an operating voltage is applied to specific electrodes formed on the TFT substrate (not shown) so as to control twist angles of liquid crystal molecules of the LC layer 25 of the LCD panel. In the preferred embodiment, the TFT master substrate 21 is made with a sodium-free glass plate. A plurality of first detection areas 211, a plurality of display areas 212, and a single second detection area 213 are formed on the glass plate. The display areas 212 are fabricated in a regular matrix/array arrangement within a main center region of the glass plate, so as to obtain the most effective usage of the area of the glass plate. Each of the display areas 212 includes a plurality of transparent/non-transparent electrodes arranged in a regular matrix/array. Each of the first detection areas 211 is located adjacent to a corresponding one of the display areas 212, with the detection area 211 electrically connected to the display area 212. The second detection area 213 is preferred located at a periphery of the TFT master substrate 21, such as at a long side edge of the glass plate.

The first detection areas 211 and the second detection area 213 are utilized as contact points for test pins of a test instrument during a process of testing the TFT master substrate 21. In particular, each of the first detection areas 211 includes a plurality of first detection ports 2111, and the second detection area 213 includes a plurality of second detection ports 2131. Further, the first detection ports 2111 are connected in parallel to the corresponding second detection ports 2131. In the illustrated embodiment, a first one of the first detection ports 2111 of each first detection area 211 is connected with a first one of the second detection ports 2131 of the second detection area 213, a second one of the first detection ports 2111 of each first detection area 211 is connected with a second one of the second detection ports 2131 of the second detection area 213, and a third one of the first detection ports 2111 of each first detection area 211 is connected with a third one of the second detection ports 2131 of the second detection area 213. Preferably, each of the first detection ports 2111 and each of the second detection ports 2131 includes a metal bump, so as to provide ready electrical contact with the test pins of the test instrument. A material of metal bumps can be chosen from copper, aluminum, tin, silver, gold, an alloy containing any suitable combination of the foregoing metals, etc.

The display areas 212 are used to display test images once the LCD panel set 2 is assembled but before the LCD panel set 2 is cut into individual LCD panels (see below). The display areas 212 are arranged in a matrix and spaced a predetermined distance one from another. Each display area 212 includes a driving circuit 2120. The driving circuit 2120 includes signal communication lines. In particular, the driving circuit 2120 includes a plurality of parallel address lines 2121 and a plurality of parallel data lines (not labeled), with the data lines being orthogonal to the address lines 2121. The intersecting address lines 2121 and data lines are typically made of metal, and form a grid pattern. Each driving circuit 2120 further includes a plurality of TFT array circuits 2122, each TFT array circuit 2122 being located in a respective cell of the grid pattern. Each of the first detection ports 2111 of the corresponding first detection area 211 are electrically connected to the address lines 2121 of the display area 212. The second detection ports 2131 of the second detection area 213 are electrically connected to the first detection ports 2111 of the first detection area 211 (see above).

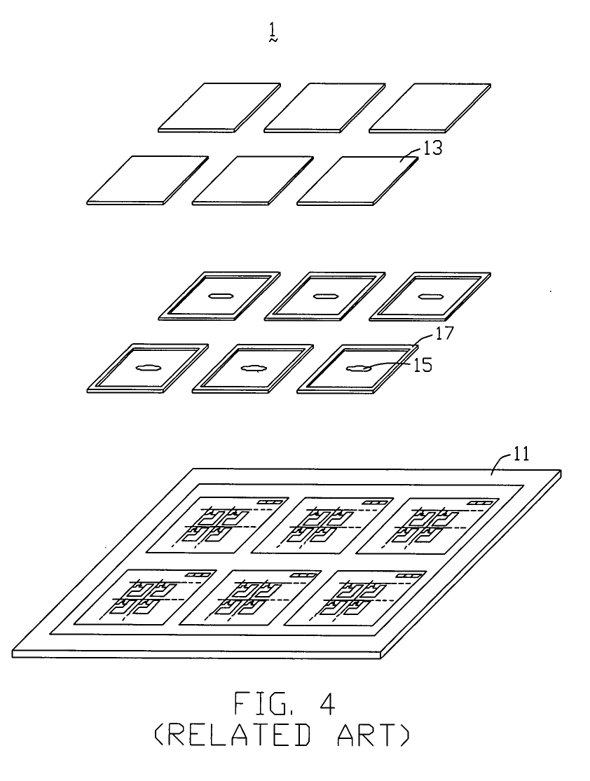

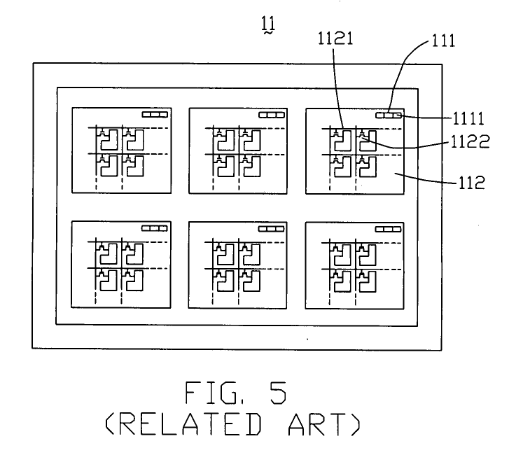

Referring to FIG. 3, this is an assembled view of the LCD panel set 2. The signal communication lines (e.g. address lines 2121, data lines) are set within the display areas 212 of the TFT master substrate 21, and are electrically connected to the first detection ports 2111 of the corresponding first detection areas 211. Further, the first detection ports 2131 are connected in parallel to the second detection ports 2111 (see above). Typically, the first detection ports 2111 and the second detection ports 2131 are made of metal layers, with the second detection ports 2131 being located at a peripheral region of the TFT master substrate 21. A material of metal layers can be chosen from copper, aluminum, tin, silver, gold, an alloy containing any suitable combination of the foregoing metals, etc.

With the above-described configuration, testing signals can be transmitted to each of display areas 212 simultaneously through the second detection ports 2131. Hence, only one round of testing signals needs to be applied in order that all of the TFT substrate units of the TFT master substrate 21 are tested. Therefore the speed and efficiency of testing of all the TFT substrate units can be improved. Further, because the testing is performed before the cutting step, if a defect is found in one of the LCD panel units, information about the defect is promptly sent back to the corresponding workstation on the production line. Parameters of the manufacturing process can then be timely adjusted, so that the defect is eliminated or at least mitigated when subsequent LCD panel sets 2 are manufactured. Compared with conventional art, the time lag between detection of the defect and correction of the problem at the workstation is reduced. For at least the above reasons, the efficiency of testing of the LCD panel units can be improved.

A preferred manufacturing process for obtaining the individual LCD panels from the LCD panel set 2 is described in the following steps:

Step 1: the TFT master substrate 21 is provided, with the first detection areas 211 and the second detection area 212 arranged as described above.

Step 2: the plurality of sealants 27 are set around the respective plurality of display areas 212 on the TFT master substrate 21, so as to define a plurality of corresponding receiving spaces within respective center portions of the display areas 212.

Step 3: the plurality of liquid crystal (LC) layers 25 are formed separately in each of the receiving spaces. The preferred forming method is an ODF process.

Step 4: the plurality of color filter substrates 23 are combined with the TFT master substrate 21 and sealed with the sealants 27 respectively. The sealants are then cured. Thereby, the LCD panel set 2 is obtained.

Step 5: an inspection and/or testing process is carried out on the LCD panel set 2, including via the aforesaid detection areas 211 and 213.

Step 6: after the inspection and/or testing process is completed, the LCD panel set 2 is cut into individual LCD panels. Only the LCD panel units which have passed the inspection and/or testing process are cut off and obtained.

Unlike in the above-described conventional technique, the present embodiments provide for inspection and/or testing of LCD panel units before the cutting step is performed. Therefore unsatisfactory LCD panel units can be detected promptly, and are not needlessly cut off from the LCD panel set 2. Hence, the time and cost of the cutting step can be reduced, and the efficiency of cutting of the LCD panel sets 2 can be improved.

As would be understood by a person skilled in the art, the foregoing preferred and exemplary embodiments are provided in order to illustrate principles of the present invention rather than limit the present invention. The above descriptions are intended to cover various modifications and similar arrangements included within the spirit and scope of the appended claims, which scope should be accorded the broadest interpretation so as to encompass all such modifications and similar structures and methods.

What is claimed is:

1. A thin film transistor master substrate used for manufacturing a plurality of liquid crystal display panels, the thin film transistor master substrate comprising:
a plurality of display areas;
a plurality of first detection areas set corresponding to the display areas respectively; and
a second detection area set at a periphery of the thin film transistor master substrate;
wherein each of the first detection areas is electrically coupled to the corresponding display area, and the first detection areas are electrically coupled in parallel to the second detection area.

2. The thin film transistor master substrate as claimed in claim 1, wherein each of the first detection areas further comprises a first detection port and the second detection area further comprises a second detection port connected to the first-detection ports in parallel.

3. The thin film transistor master substrate as claimed in claim 2, wherein the display areas comprise a plurality of metal lines connected to the corresponding first detection ports.

4. The thin film transistor master substrate as claimed in claim 3, wherein the first detection ports further comprise a plurality of metal layers connected electrically to the corresponding metal lines of the display areas.

5. The thin film transistor master substrate as claimed in claim 3, wherein the second detection ports comprise a plurality of metal bumps connected electrically to the first detection ports.

6. The thin film transistor master substrate as claimed in claim 1, further comprising a plurality of driving circuits set corresponding to each of the display areas.

7. The thin film transistor master substrate as claimed in claim 6, wherein each of the driving circuits comprises a thin film transistor array and a plurality of address lines.

8. A liquid crystal display panel set, comprising:
a plurality of color filter substrates;
a plurality of liquid crystal layers; and
a thin film transistor master substrate, comprising:
a plurality of display areas;
a plurality of first detection areas set corresponding to the display areas respectively; and
a second detection area set at a periphery of the thin film transistor master substrate;
wherein each of the first detection areas is electrically coupled to the corresponding display areas and the first detection areas are coupled in parallel to the second detection area; and
each of the liquid crystal layers is interposed between a corresponding one of the color filter substrates and the thin film transistor master substrate.

9. The liquid crystal display panel set as claimed in claim 8, wherein each of the first detection areas further comprise a first detection port and the second detection area further comprises a second detection port connected to the first detection ports in parallel.

10. The liquid crystal display panel set as claimed in claim 9, wherein the display areas comprise a plurality of metal lines connected to the corresponding first detection ports.

11. The liquid crystal display panel set as claimed in claim 10, wherein the first detection ports further comprise a plurality of metal layers connected electrically to the corresponding metal lines of the display areas.

12. The liquid crystal display panel set as claimed in claim 10, wherein the second detection ports comprise a plurality of metal bumps connected electrically to the first detection ports.

13. The liquid crystal display panel set as claimed in claim 8 further comprising a plurality of driving circuits set corresponding to each of the display areas.

14. The liquid crystal display panel set as claimed in claim 13, wherein each of the driving circuits comprises a thin film transistor array and a plurality of address lines.

15. The liquid crystal display panel set as claimed in claim 8, further comprising a plurality of sealants individually set on a boundary region around each of the thin film transistor substrates so as to seal each of the liquid crystal layers between the corresponding color filter substrate and the thin film transistor substrate.

16. A method for fabricating a plurality of liquid crystal display panels in a batch, the method comprising:
providing a thin film transistor master substrate, the thin film transistor master substrate comprising:
a plurality of display areas;
a plurality of first detection areas set corresponding to the display areas respectively; and
a second detection area set at a periphery of the thin film transistor master substrate;
wherein each of the first detection areas is electrically coupled to the corresponding display areas and the first detection areas are coupled in parallel to the second detection area;
forming a plurality of sealants, each sealant set around a corresponding one of the display areas of the thin film transistor master substrate, so as to define a plurality of receiving spaces on the thin film transistor master substrate;
forming a plurality of liquid crystal layers in the receiving spaces respectively;
providing a plurality of color filter substrates;
combining the color filter substrates with the display areas of the thin film transistor master substrate respectively so as to form a plurality of liquid crystal panel units;
testing the liquid crystal panel units by transmitting signals through the second detection area and the first detection areas; and
cutting the liquid crystal panel units into individual liquid crystal panels.

17. The method as claimed in claim 16, wherein each of the first detection areas further comprises a first detection port and the second detection area further comprising a second detection port connected to the first detection ports in parallel.

18. The method as claimed in claim 17, wherein the display areas comprise a plurality of metal lines connected to the corresponding first detection ports.

19. The method as claimed in claim 18, wherein the first detection ports further comprise a plurality of metal layers connected electrically to the corresponding metal lines of the display areas.

20. The method as claimed in claim 18, wherein the second detection ports comprise a plurality of metal bumps connected electrically to the first detection ports.
